(19) United States
(12) Patent Application Publication
(10) Pub. No.: US 2018/0350510 A1
(43) Pub. Date: Dec. 6, 2018

(54) WINDING ARRANGEMENT

(71) Applicant: SIEMENS AKTIENGESELLSCHAFT, München (DE)

(72) Inventors: TIM-FELIX MAI, WENDLINGEN (DE); RICHARD SILLE, KIRCHHEIM (DE); STEFFEN WEINERT, WANGEN (DE)

(21) Appl. No.: 16/061,704

(22) PCT Filed: Nov. 23, 2016
(86) PCT No.: PCT/EP2016/078500

§ 371 Date: Jun. 13, 2018

(30) Foreign Application Priority Data
Dec. 18, 2015 (DE) 10 2015 226 097.6

(51) Int. Cl. H01F 27/28; H01F 41/071

(52) U.S. Cl. CPC H01F 27/2847; H01F 41/071

(57) ABSTRACT

A winding arrangement includes a plurality of winding sections being mutually spaced apart in axial direction and electrically connected to one another forming a series circuit. Each winding section includes a conductor wound from an inner end to an outer end of the winding section and thus enlarges the winding section in radial direction. At least one winding section is electrically connected at its outer end to the inner end of the following winding section in axial direction, which can be cost effectively produced. The winding sections thereof are disposed at a comparatively small mutual separation. At least one following winding section in axial direction forms a stepped region in which the inner end thereof is disposed in the radial direction at the height of the outer end of the winding section to which it is electrically connected. A transformer and a coil having the winding arrangement are also provided.

The invention relates to a winding arrangement comprising a number of winding sections arranged at a distance from one another in the axial direction and electrically connected to one another so as to form a series circuit, which winding sections each have a conductor, which is wound from an inner end to an outer end of the respective winding section and in the process enlarges the winding section in the radial direction, wherein at least one winding section is electrically connected at its outer end to the inner end of the winding section that follows in the axial direction.

The invention also relates to a transformer and to a coil or inductor comprising a winding arrangement of this kind.

The winding arrangement mentioned above is known, for example, from EP 2 251 877 B1. The winding arrangement shown there consists of a series circuit of so-called disk windings, which are arranged at a distance from one another. In this case, the outer end of each disk winding is connected to the inner end of the respective disk winding arranged adjacently in the axial direction. In this way, during production of the entire winding, the conductor in each disk winding can always be wound onto a shaping roll from the inside to the outside. This simplifies the production of the winding arrangement with a cost saving as a result. However, it is disadvantageous that the intermediate section of the conductor, which extends between the disk windings, has to bridge not only the axial distance of the adjacent disk windings but also the radial extent of the winding. The adjacent disk windings therefore have to be arranged at a great distance from one another in order to provide space for said intermediate section.

So-called continuous turned-over windings are also known from experience. In continuous turned-over windings, the outer end of a disk winding is connected to the outer end of the disk winding that follows in the axial direction, wherein, however, said disk winding is wound from the outside to the inside. However, the change in winding direction during production is complex and leads to additional costs.

The object of the invention is to provide a winding arrangement of the kind mentioned at the outset, which can be produced in a cost-effective manner and the winding sections of which are arranged at a comparatively short distance from one another.

The invention achieves this object by virtue of the fact that at least one winding section that follows in the axial direction forms a stepped region, in which the inner end of said winding section is arranged in the radial direction at the height of the outer end of the winding section, to which outer end said winding section is electrically connected.

The invention provides a winding arrangement, in which the one winding section is connected to the respective adjacent winding section by simply bending the conductor, without the conductor having to be guided over relatively long paths between adjacent winding sections. In this case, all the winding sections have the same winding direction. The winding direction thus does not change in the context of the invention. The entire winding arrangement preferably consists of a single wound conductor. Said continuous conductor is wound such that winding sections are formed, which are arranged so as to follow one another in the axial direction. Winding the conductor in a spiral-shaped manner at certain distances forms winding sections. In the winding sections, the conductor tracks that are insulated from one another bear against one another and, as the number of windings increases, enlarge the winding section in a direction referred to here as the radial direction. The winding process forms circumferentially closed winding sections, which delimit a section interior. The section interiors of the winding sections are at least partially aligned in the axial direction, so that the stack of winding sections defines an inner contour, which is referred to in the following text as roll interior.

In order to design the conductor or conductor section that connects the winding sections to one another to be as small and compact as possible, with the exception of the first winding section of the series circuit, each winding section forms an eccentric stepped region, in which the inner winding layer of said winding section is at a greater distance from an imaginary central axis of the roll interior than outside of the stepped region. This distance, which is enlarged compared to the other sections, corresponds to the distance between the inner and the outer end of the adjacent winding sections; in other words, it thus corresponds to the thickness of the winding. The outer conductor therefore has to be guided only laterally, that is to say in the axial direction, from the outer winding layer of the respective winding section to the inner winding layer of the adjacent winding section. The conductor bent in this way in said stepped region then serves as inner winding layer of said adjacent winding section. By raising the inner winding layer to the level of the outer winding layer in the stepped region, the conductor section or the conductor between the winding sections can be formed to be short so that the distance between the winding sections can likewise be reduced.

Advantageously, with the exception of the first winding section of the series circuit, each winding section forms a stepped region. According to this variant of the invention, the first winding section forms the so-called start of the winding arrangement, by means of which start the winding arrangement is connected, for example, to the phase connection of a transformer or an inductor. However, the outer end of the first winding section is then connected in the stepped region to the inner end of the winding section that follows in the axial direction, so that said winding section is then the first winding section that has a stepped region. This applies accordingly to the winding sections that follow in the axial direction.

According to a preferred configuration of the invention, each winding section is a disk winding designed in a disk-shaped manner. In a disk winding, the individual winding layers are wound precisely above one another so that they extend in a disk-shaped manner effectively in a common tier or “plane”. According to this advantageous further development, the winding arrangement is formed in an even more compact manner.

Advantageously, each disk winding is formed in a circumferentially closed manner and delimits a section interior. The section interiors of the disk windings overlap in the stack, which results from the successive arrangement of the disk winding in the axial direction, so that space is provided for a limb of a transformer or inductor core.

In one variant thereof, each disk winding forms a circular annular section outside of the stepped region. This makes it possible, in the production of the winding arrangement according to the invention, to obtain a circular-cylindrical molded body on which the winding sections can be wound. This reduces the production costs.

According to one preferred configuration of the invention, the disk windings arranged next to one another in the axial direction delimit a circular-cylindrical interior, which has a central axis, wherein the first winding layer of each disk winding is at a greater distance from the central axis in the stepped region than in the annular region. The circular-cylindrical interiors of a winding make it possible to hold conventional limbs of a yoke so that there is no need for complex adjustment.

Expediently, the center of the stepped region of each disk winding spans an angle α with respect to the central axis with the center of the stepped region of the directly adjacent disk winding. This twisting of the stepped regions around the central axis is necessary in order to bring the outer winding layer of the disk windings to the radial level or the radial height of the first winding layer of the respective disk winding that follows.

According to a further development related thereto, each disk winding is arranged in alignment with the respective next disk winding but one. According to this variant, the entire winding arrangement forms eccentric protrusions at only two locations. This likewise simplifies the adjustment of the winding arrangement and the subsequent handling thereof.

Advantageously, the angle α is 180 degrees. According to this variant, the protrusions are located opposite one another on different sides of the winding arrangement. As a departure therefrom, the angle α is in the range of from 10 to 30 degrees. According to this variant of the invention, the two protrusions are arranged on the same side of the winding arrangement, for example at the front. In this way, it is possible to delimit a conductor free space, which serves to hold feed lines or outlet lines.

In principle, any kind of conductor can be used in the context of the invention. The conductor is thus, for example, a drawn wire conductor or a flat film conductor.

Advantageously, the conductor is a strip conductor formed in a strip shape. For example copper or preferably aluminum is considered as the strip conductor material, wherein the conductor or in this case the strip-shaped strip conductor is surrounded at least in sections in each case by an insulating layer. The insulating layer may be, for example, an insulating coating layer or an insulating film. The insulating film is placed between consecutive roll layers during winding.

According to an expedient configuration related thereto, the strip conductor is bent over twice in the stepped region. By way of the double bending, the strip conductor can be guided particularly easily in the axial direction from the respective one winding section to the winding section that follows.

Advantageously, the winding arrangement is part of a transformer or a coil or inductor.

Further expedient configurations and advantages of the invention are the subject matter of the following description of exemplary embodiments of the invention with reference to the figures of the drawing, wherein identical reference signs refer to components having the same function and wherein

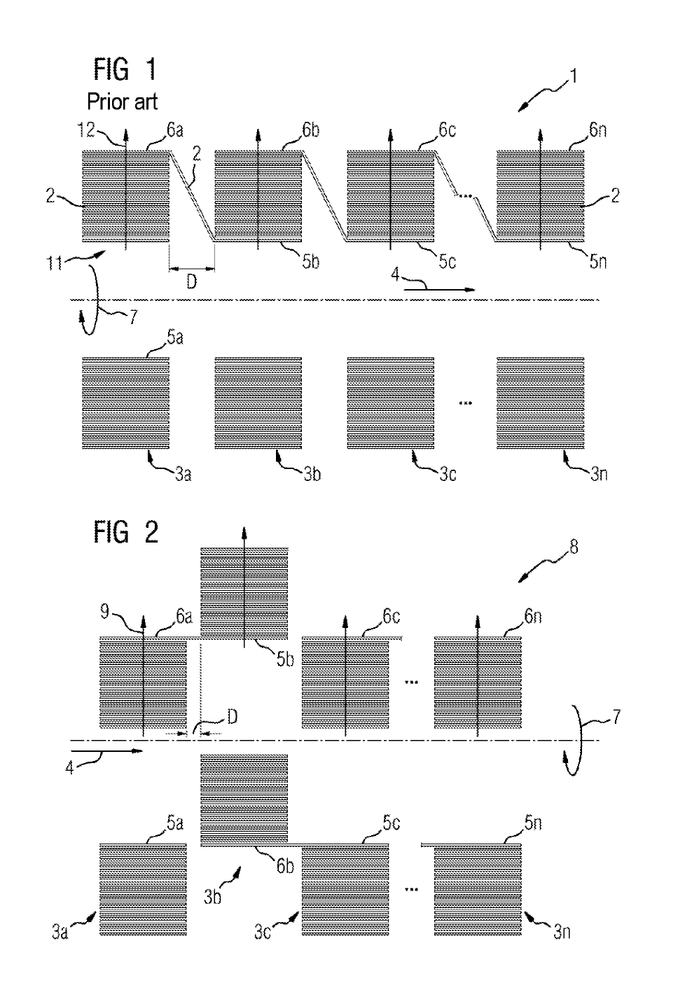

FIG. 1 shows a winding arrangement according to the prior art,

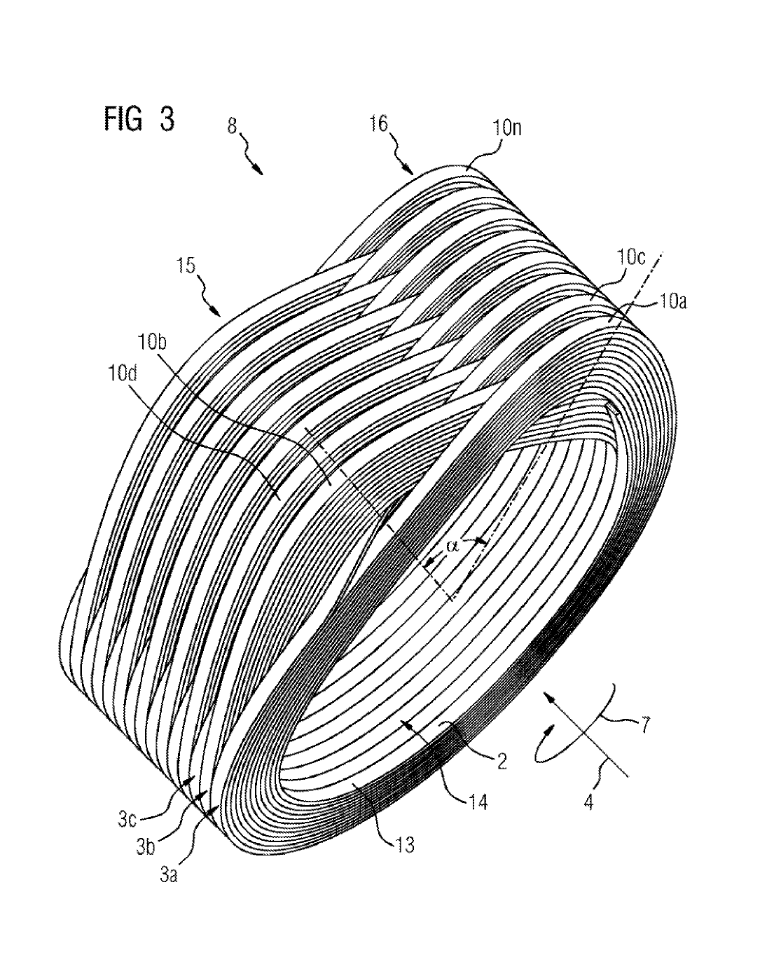

FIG. 2 shows an exemplary embodiment of the winding arrangement according to the invention,

FIG. 3 shows a perspective view of an exemplary embodiment of the winding arrangement according to the invention,

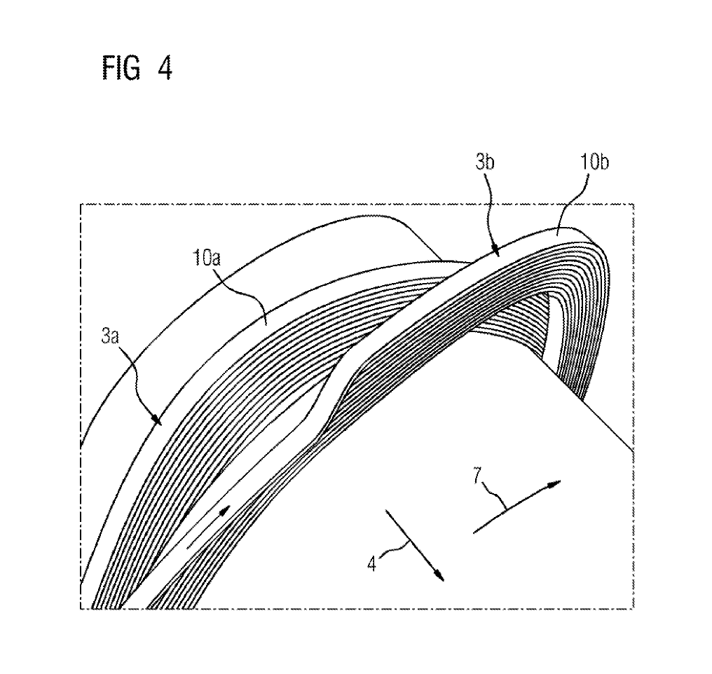

FIG. 4 shows the winding arrangement according to FIG. 3 during the production process,

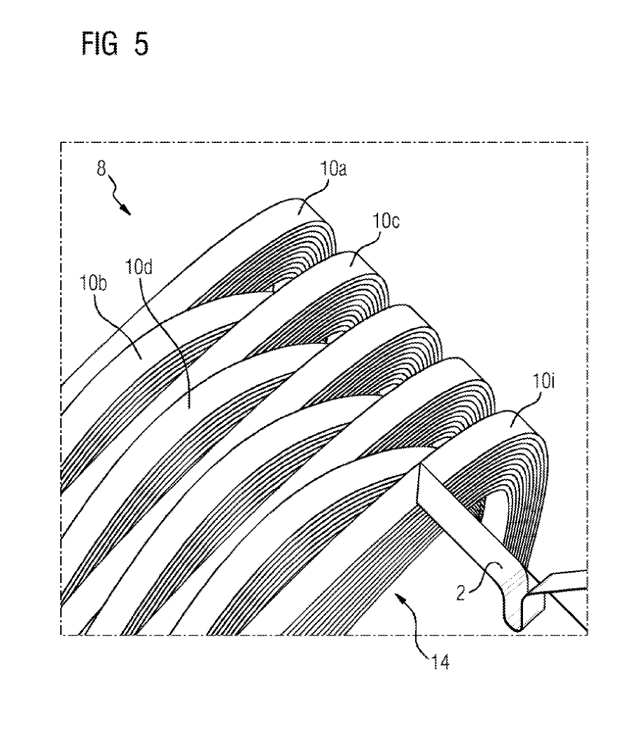

FIG. 5 shows a partial view of a further exemplary embodiment of a winding arrangement according to the invention,

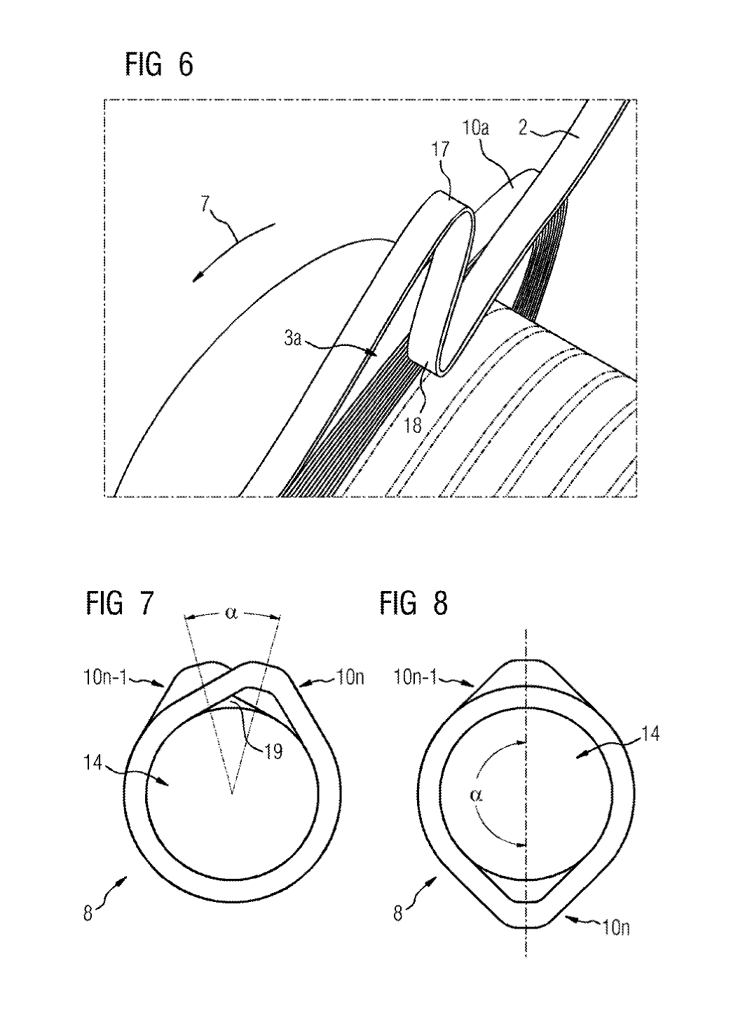

FIG. 6 shows the winding arrangement according to FIG. 5 during the production process,

FIG. 7 shows a schematic plan view of the winding arrangement according to FIG. 3 and

FIG. 8 shows a schematic illustration of a further exemplary embodiment of a winding arrangement according to the invention.

FIG. 1 shows a winding arrangement 1 according to the prior art. The winding arrangement 1 shows a winding of a conductor 2, which is electrically insulated from the next layer, for example by interposition of an insulating film or by an insulating coating. Said conductor 2 is wound so that the layers of the conductor 2 lie one above the other in a spiral-shaped manner in one tier. Said conductor tracks lying one above the other in a spiral-shaped manner are referred to here as winding layers. The first winding layer therefore delimits a winding interior, which is referred to here as section interior 11. The winding layers lying one above the other lie one above the other in one tier. In other words, the winding layers form disk-shaped disk windings 3a, 3b, 3c . . . 3n as winding section. The winding sections are arranged behind one another in the axial direction 4. In this case, the disk windings 3a, 3b, 3c . . . 3n are all arranged at a distance D from one another, wherein the distance D can be different. The distance between the disk windings 3a and 3b is, for example, smaller than the distance between the disk windings 3b and 3c. Each of said disk windings 3a, 3b, 3c . . . 3n has an inner end 5a, 5b, 5c and 5n and an outer end 6a, 6b, 6c and 6n. Furthermore, each disk winding 3a, 3b, 3c . . . 3n is wound from the inside to the outside, as is indicated for each disk winding 3a, 3b, 3c . . . 3n by an arrow 12 in the radial direction. Said winding direction is also indicated by a curved arrow 7. It can be seen that all the disk windings 3a, 3b, 3c . . . 3n have the same winding direction 7. For the electrical connection, for example, of the disk winding 3a to the disk winding 3b, the outer end 6a of the disk winding 3a is connected to the inner end 5b of the disk winding 3b. In order to provide space for the conductor section 2 extending between the disk windings 3a and 3b, said disk windings have to be arranged at a distance D from one another. This applies accordingly to all other disk windings 3b, 3c and 3n.

FIG. 2 shows an exemplary embodiment of the winding arrangement 8 according to the invention, which, in accordance with the winding arrangement 1 from FIG. 1, forms an electrical series circuit of winding sections, in this case disk windings 3a, 3b, 3c . . . 3n. As in FIG. 1, all the disk windings 3a, 3b, 3c . . . 3n have the same winding direction 7, that is to say are wound from the inner end 5a, 5b, 5c . . . 5n to the respective outer end 6a, 6b, 6c . . . 6n of each disk winding 3a, 3b, 3c . . . 3n. As in FIG. 1, the outer end 6a, 6b, 6c . . . 6n -1 of the disk windings 3a, 3b, 3c . . . 3n -1 is in each case connected to the inner end of a further disk winding 3b, 3c, 3d that follows directly or immediately in the axial direction, with the exception of the last subwinding 3n of the series circuit. In the exemplary embodiment shown, said last subwinding is connected by way of its outer end 6n to a high-voltage connection (not illustrated in the figure) of said transformer. The inner end 5a of the first disk winding 3a is connected to a further high-voltage connection of said transformer.

As is illustrated schematically in FIG. 2, the disk winding 3b is raised with respect to the disk winding 3a in the radial direction 9 in the region of the connection of 6a to 5b to such an extent that its inner end 5b is situated at the same “radial” height as the outer end 6a of the disk winding 3a. In the context of the invention, the conductor 2 therefore has to be bent only from the “tier” of the disk winding 3a in the axial direction 4 in order to be transferred to the tier of the adjacent disk winding 3b. Said conductor forms the first winding layer there. The further winding layers can be wound in the same direction by simply winding further. A long conductor connection between the winding sections 3a, 3b, 3c . . . 3n as in FIG. 1 is therefore prevented in the context of the invention. At the same time, in contrast to the so-called continuous turned-over windings, the winding direction 7 for all the disk windings 3a, 3b, 3c . . . 3n is identical. The disk windings 3a, 3b, 3c . . . 3n can thus be arranged at a short distance D from one another, wherein the production of the winding arrangement 8 remains cost-effective.

FIG. 3 shows a perspective view of the winding arrangement 8 according to FIG. 2. It can be seen that the disk windings 3a, 3b, 3c are arranged behind one another in the axial direction 4 at a short distance from one another. In the illustration shown in FIG. 3, the disk winding 3a is facing toward the viewer. It can be seen that each disk winding 3a, 3b, 3c . . . 3n is formed in a circumferentially closed manner and a section interior 13 is thus delimited. The entire stack of disk windings 3a, 3b, 3c . . . 3n, that is to say the winding arrangement 8, delimits an inner cavity, which is referred to here as interior 14. The interior 14 contains essentially the section interiors 13 that are aligned with one another.

The interior 14 serves to hold a magnetizable material, which is set up to guide a magnetic field with a low magnetic resistance. In a plan view, the individual disk windings 3a, 3b, 3c . . . 3n are not formed in a circular shape and therefore do not individually delimit a circular section interior 13. Instead, each disk winding 3a, 3b, 3c . . . 3n has an eccentric stepped region 10a, 10b, 10c . . . 10n, which is at a greater distance from an imaginary central axis of the circular-cylindrical interior 14 of the winding arrangement 8 than the remaining section of each disk winding 3a, 3b, 3c . . . 3n, which in a plan view follows a circular shape. It can also be seen that the stepped region 10a is not arranged in alignment with the stepped region 10b of the disk winding 3b, which directly follows the first disk winding 3a in the axial direction. Instead, the stepped region 10b is offset in a circumferential manner with respect to the stepped region 10a so that the two center points of the stepped regions 10a and 10b span an angle α with one another with respect to the imaginary central axis of the interior 14 of the winding arrangement 8. It can furthermore be seen that the stepped region 10c of the next disk winding 3c but one is arranged in alignment with the stepped region 10a of the first disk winding 3a. This applies accordingly to the stepped regions 10b and 10d. Each disk winding 3a, 3b, 3c . . . 3n is therefore arranged by way of its stepped region 10a, 10b, 10c . . . 10n in alignment with the respective next disk winding 3a, 3b, 3c . . . 3n but one, wherein the stepped regions 10a, 10b, 10c . . . 10n of disk windings 3a, 3b, 3c . . . 3n, which follow one another directly, are rotated with respect to one another. In the winding arrangement 8, overall two eccentric convex portions 15, 16 can therefore be seen, which are formed by the stepped regions 10a, 10c, 10e . . . 10n-1 and the stepped regions 10b, 10d, 10f . . . 10n, respectively. If the disk windings 3a, 3b, 3c . . . 3n are numbered using integer numbers starting from 1, the one convex portion 15 is formed by the disk windings 3a, 3d, 3e . . . 3n -1 with even numbers and the other convex portion 16 is formed by the disk windings 3b, 3d, 3f . . . 3n with uneven numbers.

It can also be seen in FIG. 3 that the conductor 2 in the outer winding layer in the stepped region 10b is lead out, that is to say bent, from the plane of the disk winding 10a in a manner offset in the axial direction and so the inner end 5b of the second disk winding 3b is formed. The inner end 5a is provided to terminate the outlet line of a transformer situated at high voltage during operation. The conductor 2 of the outer winding layer of the disk winding 3b in contrast is bent in the stepped region 10c axially in the direction of the disk winding 3c so that said stepped region forms the inner end of the disk winding 3c there. This is covered in FIG. 3 by the disk winding 3a, however.

FIG. 4 illustrates, in a perspective illustration, how the conductor 2 of the disk winding 3b is bent during the production process in the stepped region 10b of the disk winding 3c that follows and is still to be wound. The stepped region 3a of the first disk winding can also be seen, using which said first disk winding is connected at the side facing away from the viewer to the housing of the transformer.

FIG. 5 shows a perspective view of a partial view of a further exemplary embodiment of the winding arrangement according to the invention. The strip conductor 2 wound to form the disk windings 3a, 3b, 3c . . . 3n is formed as somewhat wider and thinner in the strip conductor 2 shown in comparison to FIG. 3, wherein the strip conductor 2 consisting of aluminum is covered by an insulating film. In particular, the stepped regions 10a, 10b, 10c . . . 10n can be seen, wherein the respective next disk winding 3a, 3c, 3e or 3b, 3d, 3f but one lie opposite in alignment. The stepped regions 10a and 10b of adjacent disk windings 3a and 3b are twisted with respect to one another and span an angle α with one another with respect to the central axis of the hollow-cylindrical interior 14 of the winding arrangement 8 so that the strip conductor 2 can be transferred to the tier of the disk winding that follows in the axial direction by bending said strip conductor in the axial direction.

FIG. 6 shows the winding arrangement according to FIG. 5 during the production process. It can be seen here how the strip conductor 2 is bent during production. The conductor 2 illustrated in FIGS. 5 and 6 is of flexible form such that it can be bent twice in the stepped region 10. At a first bending location 17, the conductor strip 2 is bent backward counter to the winding direction 7. At a second bending location 18, the strip conductor 2 is bent again so that it extends in the desired winding direction 7 again. In this double bending process, the conductor 2 is offset in the axial direction so that it can form the first winding layer of the disk winding that follows.

FIG. 7 shows a further exemplary embodiment of the winding arrangement 8 according to the invention. In this view, it can be seen particularly well that the disk windings are arranged in alignment with one another. In FIG. 7, it can be seen that the stepped regions 10n and 10n-1 of the disk windings 3n and 3n-1 span an angle α with one another with the center point of the circular-cylindrical interior 14. The circular-cylindrical interior 14 is indicated schematically by a dashed circular line. It can be seen that the interior 14 is not designed as completely circular-cylindrical. Instead, on account of the angle α between in this case 20 degrees, an additional line guiding space 19 is formed, which can serve to hold conductors, cables, connections and the like when, for example, a subwinding and a limb of a core extend in the circular-cylindrical interior.

FIG. 8 shows a further exemplary embodiment of the winding arrangement 8 according to the invention, which differs from the exemplary embodiment shown in FIG. 7 in that the angle α that the stepped regions 10n and 10n -1 span with one another with respect to the central axis of the circular-cylindrical interior 14, is 180°. It can be seen that in this configuration the inner contour of the disk windings jointly delimit the circular-cylindrical interior so that a more compact winding arrangement is created without additional space for guiding cables, as in FIG. 7.

1-13. (canceled)

14. A winding arrangement, comprising:
a plurality of winding sections following one another in an axial direction, being disposed at a distance from one another in said axial direction and being electrically connected to one another to form a series circuit;
said winding sections each having an inner end and an outer end;
each winding section having a conductor being wound from said inner end to said outer end of said respective winding section and enlarging said winding section in a radial direction;
said outer end of at least one of said winding sections being electrically connected to said inner end of a winding section following in said axial direction;
at least one of said winding sections following in said axial direction forming a stepped region; and
said inner end of said at least one winding section in said stepped region being disposed at a height in said radial direction being equal to a height of said outer end of said winding section, and said outer end of said winding section being electrically connected to said at least one winding section.

15. The winding arrangement according to claim 14, wherein said winding sections of said series circuit include a first winding section, and each of said winding sections forms a respective stepped region except for said first winding section.

16. The winding arrangement according to claim 15, wherein each of said winding sections is a respective disk winding having a disk shape.

17. The winding arrangement according to claim 16, wherein each of said disk windings is circumferentially closed and delimits a respective section interior.

18. The winding arrangement according to claim 17, wherein each of said disk windings forms a respective circular annular section outside of said stepped region.

19. The winding arrangement according to claim 18, wherein:
said disk windings are stacked in said axial direction and delimit a circular-cylindrical interior having a central axis; and
each of said disk windings has a first winding layer disposed at a greater distance from said central axis in said stepped region than in said annular section.

20. The winding arrangement according to claim 19, wherein a center of said stepped region of each disk winding and a center of said stepped region of a directly adjacent disk winding span an angle with one another relative to said central axis.

21. The winding arrangement according to claim 20, wherein each of said disk windings is aligned with a respective disk winding after the next.

22. The winding arrangement according to claim 21, wherein said angle is between 10 degrees and 30 degrees or is 180 degrees.

23. The winding arrangement according to claim 14, wherein said conductor is a strip conductor having a strip shape.

24. The winding arrangement according to claim 15, wherein said conductor is a strip conductor having a strip shape, and said strip conductor is bent over twice in each of said stepped regions.

25. A transformer, comprising a winding arrangement according to claim 14.

26. A coil, comprising a winding arrangement according to claim 14.
